(19) United States
(12) Patent Application Publication
(10) Pub. No.: US 2003/0084744 A1
(43) Pub. Date: May 8, 2003

(54) Adjustable assembly

(76) Inventors: Chantal S. Parenteau, Troy, MI (US); Brian norman Orr, Chesterfield, MI (US)

Correspondence Address: DELPHI TECHNOLOGIES, INC., Legal Staff, P.O. Box 5052, Mail Code: 480-414-420, Troy, MI, 48007-5052, US

(21) Appl. No.: 10/015,198

(22) Filed: Nov. 5, 2001

(51) Int. Cl. G05G 1/14

(52) U.S. Cl. 74/512

(57) ABSTRACT

An adjustable toe pan assembly including an adjustable pedal assembly and a toe pan assembly. The adjustable pedal assembly includes a support structure that connects to a vehicle and a pedal assembly including a pedal disposed adjacent to the support structure and connected to the support structure. An actuator is connected with the pedal assembly to move the pedal to a desired position. The toe pan assembly is connected to an actuator which moves the toe pan assembly in relation to the pedal assembly such that a specified distance is maintained between the pedal and toe pan assembly.

### FIELD OF THE INVENTION

The subject invention relates to adjustable assemblies for vehicles, and more particularly to an adjustable assembly that has an adjustable toe pan assembly that moves in conjunction with an adjustable pedal assembly such that a specified distance is maintained between the pedal and toe pan assemblies.

### BACKGROUND OF THE INVENTION

A person skilled in the art of vehicle pedals knows that a pedal's location may be adjusted to accommodate different types of drivers. For example, a driver may desire to move the brake, clutch and accelerator pedals closer if the drive is shorter in stature. Various mechanisms have been developed in the art for moving pedals fore and aft with respect to the vehicle and the driver.

For example U.S. Pat. Nos. 5,964,125 and 5,855,143 disclose systems that may be used to move pedals fore and aft in a horizontal fashion.

It has been shown that during the act of braking, the foot can be placed in a vulnerable position, especially when the heel is not supported adequately. During braking, the foot pivots about its point of contact with the toe pan or floorplan area. In this situation, if the foot is not centered in the middle of the pad, the foot is not ideally positioned ergonomically. Ergonomic positioning of the foot can prevent twisting of the foot and can also prevent the heel of the foot from moving under the pedal.

There is, therefore, a need in the art to provide a mechanism wherein the foot can be supported sideways as well as in the heel area. Such a design would maintain an ergonomic position of the foot in relation to a floor pan and pedal.

Various efforts have been made in the art to prevent injuries to lower extremities or the foot region including air bag systems that are placed in the floor or toe pan area. For example, U.S. Pat. No. 6,158,766 discloses a vehicle floor system that incorporates an air bag for raising the feet of a vehicle occupant upon impact to prevent engagement of the feet with the vehicle toe pan. Specifically the U.S. Pat. No. 6,158,766 discloses an air bag assembly that is integrated into the carpet and deployed when the vehicle is in a collision.

U.S. Pat. No. 6,213,505 discloses an apparatus to protect the lower extremities of an occupant of a vehicle. The apparatus includes a sheet member that extends along the floor of the vehicle. There is included an actuation power source that pulls the sheet member to tension when initiated by a crash sensor. Under tension, the sheet member separates from the vehicle floor by a distance greater than the original position of the sheet member. Again, the apparatus of the U.S. Pat. No. 6,213,505 is initiated when the vehicle is in a collision.

Due to the use of power adjustable pedals in many of today's vehicles, the distance between the toe or floor pan and the pedal maybe changed thereby affecting the ergonomic positioning of the foot. As can be seen from the above referenced U.S. patents, there is a need in the art for system that maintains the ergonomic positioning of the foot and is available in many situations including a sudden breaking maneuver that does not result in a collision. The above referenced patents are limited in that the systems are only initiated when a collision sensor is activated.

### SUMMARY OF THE INVENTION

An adjustable toe pan assembly including an adjustable pedal assembly and a toe pan assembly. The adjustable pedal assembly includes a support structure that is adapted to connect to a vehicle. There is also included a pedal assembly that includes a pedal that is disposed adjacent the support structure and is operatively coupled to the support structure. An actuator is interconnected with the pedal assembly to move the pedal assembly to a desired position. A toe pan assembly is operatively connected to an actuator wherein the toe pan assembly moves in relation to the pedal assembly such that a specified distance is maintained between the pedal assembly and the toe pan assembly.

### BRIEF DESCRIPTION OF THE DRAWINGS

FIG. 1 is a perspective view detailing the adjustable pedal and toe pan assembly of the present invention.

FIG. 2 is an alternative perspective view detailing the adjustable pedal and toe pan assembly of the present invention.

FIG. 3 is a perspective view detailing the foot rest portion and toe pan portion of the present invention.

FIG. 4 is a perspective view detailing the brake and clutch pedal assembly of the present invention.

FIG. 5 is a perspective view detailing the electronic throttle control pedal of the present invention.

### DETAILED DESCRIPTION OF THE PREFERRED EMBODIMENT

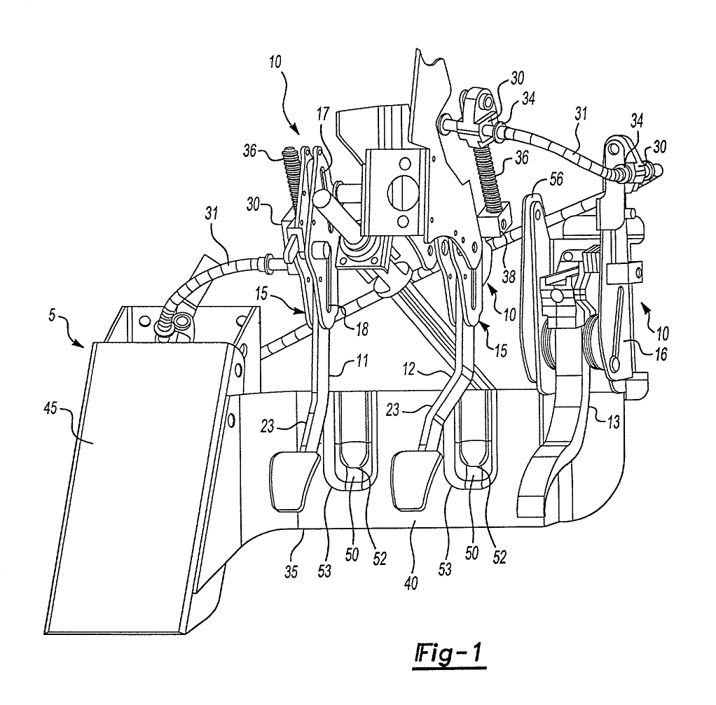

With reference to FIG. 1, there is shown the adjustable toe pan assembly 5 of the present invention including an adjustable pedal assembly 10 and a toe pan assembly 35.

In the pictured preferred embodiment of FIG. 1, the adjustable pedal assembly 10 includes three adjustable pedals including an adjustable clutch pedal 11, an adjustable brake pedal 12, and an adjustable electronic throttle control pedal 13. Each of the adjustable pedals 11, 12 and 13 include a support structure 15 or 16 that is adapted to connect to the vehicle (not shown).

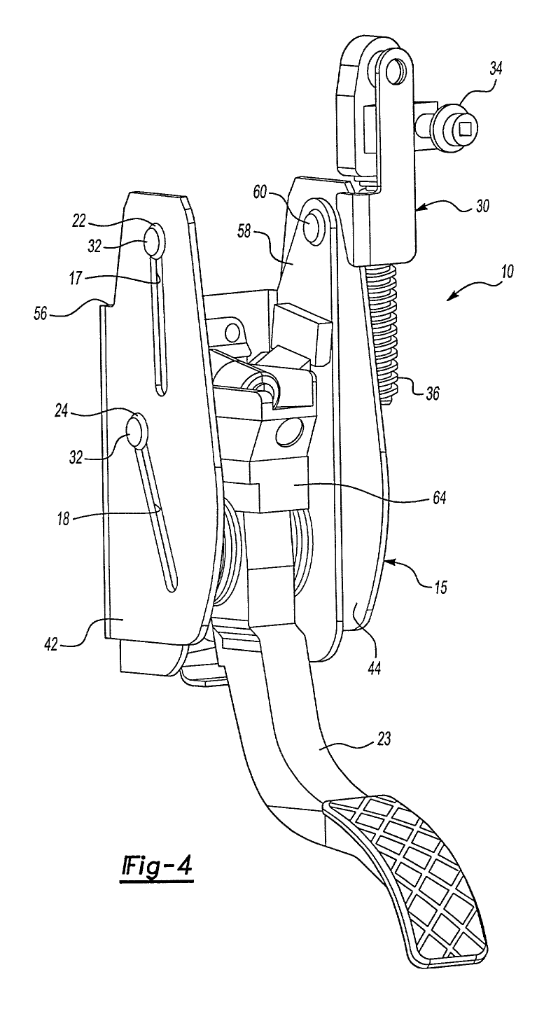

With reference to FIGS. 1 and 4, the support structure 15 of the clutch pedal 11 and brake pedal 12 includes first and second slots 17 and 18 which are arranged in a spaced apart manner. The pedal assembly 10 for the clutch 11 and brake 12 pedals, respectively, include a pedal 23. First and second pins 24, 26 extend from the pedal assembly 10 through the first and second slots 17, 18 whereby the pedal assembly 10 is supported for sliding movement on the support structure 15 along the slots 17, 18. An actuator 30 is interconnected with the pedal assembly 10 for sliding the pedal assembly 10 to a desired position along the support structure 15.

The slots 17, 18 are elongated straight slots with the first slot 17 defining a first linear axis and the second slot 18 defining a second linear axis. The first slot 17 extends generally in a vertical direction, while the second slot 18 extends below the first slot and at an angle to the first slot whereby the first and second axis intersect.

The pins 24, 26 may extend from or through the pedal 23. In the embodiment shown in FIG. 4, the pins 24, 26 have a suitable retaining structure 32 for retaining the pin 24, 26 in the respective slots 17,18. The structure maybe a flange or a retaining clip.

As shown in FIGS. 1,2 and 4 the actuator 30 includes a cable 31 that extends through a hollow shaft 34 and rotates the shaft about its axis. Through an appropriate gear (not shown) this movement drives the jackscrew 36 which causes the nut 38 to move the pin 24, 26 up and down the respective slots 17, 18.

In a preferred embodiment and with reference to FIG. 4, the support structure 15 for the brake and clutch pedals 11,12 respectively, has a first plate 42 defining first and second slots 17,18 and a second plate 44 that is disposed parallel to the first plate 42. The second plate 44 defines third and fourth slots 46,48 arranged parallel to the first and second slots 17, 18, respectively. The first and seconds plates 42, 44 are connected by a number of double shouldered rivets. As can be seen in FIGS. 1,2 and 4 the plates are interconnected to form a U-shaped bracket.

The support structure 15 is fixed to the vehicle in a pivoting arrangement. The support structure 15 includes a pivoting attachment 50 adapted to attach to the vehicle whereby the support structure 15 may pivot with respect to the vehicle in response to operational forces applied to the pedal 23. With reference to FIGS. 1, 2 and 4 the first pin 24 extends through the first slot 17, through the pedal 23 and to the third slot 46. The second pin 26 extends through the second slot 18, through the pedal 20 and through the fourth slot 48. When the driver pushes on the pedal 23, the pedal 23 and the support structure 15 will move together by pivoting with respect to the vehicle.

With respect to the electronic throttle control pedal 13, the support structure 16 includes a fixed attachment relationship whereby the support structure 16 does not move with respect to the vehicle when operational forces are applied to the pedal 23. With reference to FIGS. 1 and 5, the fixed attachment is the attachment plate 56. As can be seen in FIGS. 1, 2 and 5, the pedal assembly 10 for the electronic throttle control pedal 13 includes a bracket 58 including first through fourth pins 24, 26, 60, 62 extending from the bracket 58 with one pin extending through each of the slots 17, 18, 46, 48. The pedal 23 is pivotally connected to the bracket 58 whereby an electronic throttle control module 64 is associated with the pedal 23.

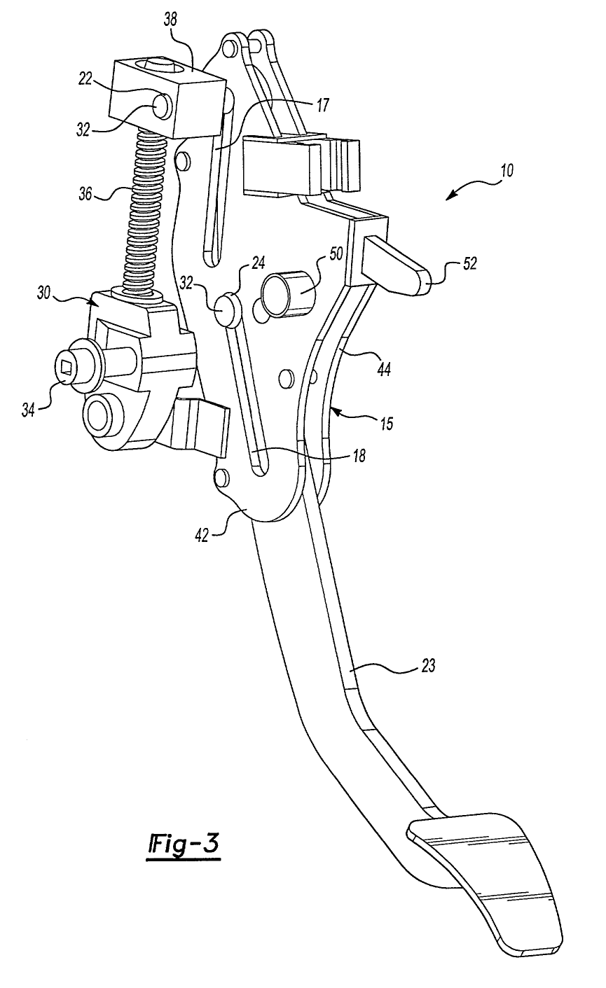

The toe pan assembly 35 is operatively connected to at least one actuator 30 to move the toe pan assembly 35 in relation to the pedal assembly 10 to maintain a specified distance between the pedal assembly 10 and the toe pan assembly 35, as best seen in FIG. 3. With reference to FIGS. 1, 2 and 3 the toe pan assembly 35 includes a toe pan portion 40 connected to a foot rest portion 45. The toe pan portion 40 includes at least one recess 50 formed therein to accommodate at least one pedal assembly 10 when the pedal is depressed fully. The toe pan portion 40 and footrest portion 45 preferably has energy absorbing properties. Specifically, the toe pan assembly 35 may be made of an energy absorbing material including foam rubber, Styrofoam, or other plastic materials that will absorb the force of an occupant's foot.

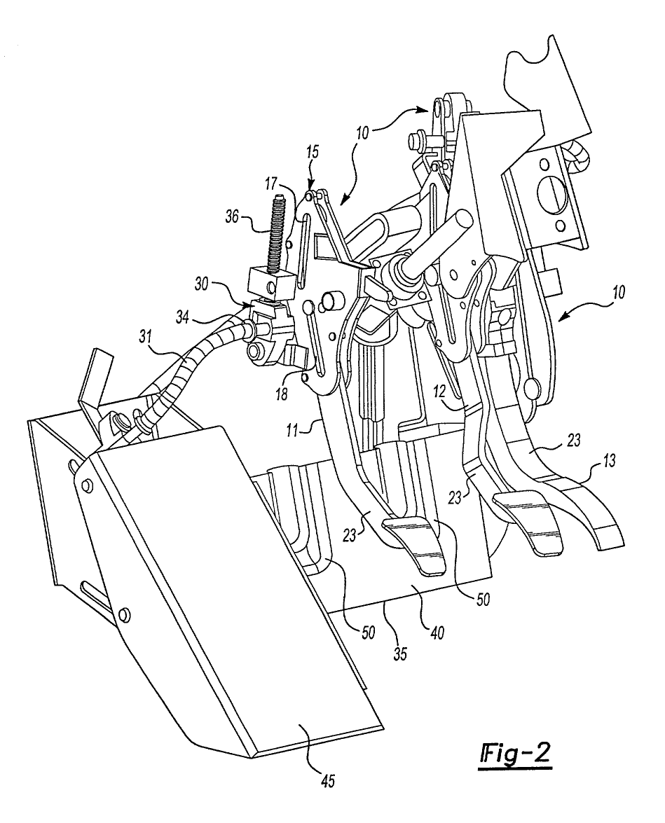

With reference to FIGS. 1 and 2 the recesses 50 formed in the toe pan portion 40 correspond with the clutch 11 and brake 12 pedals respectively. As can be seen, when the pedals are in a fully depressed condition, the recesses 50 accommodate the pedals 23 and the foot will be maintained sideways by the walls 52 of the recess 50, as well as in the heel region by the wall 53 of the recess 50. Therefore, during an emergency braking maneuver, when the brake pedal 12 is fully depressed, the foot is maintained in an ergonomic position.

As shown in FIGS. 1, 2, and 3 the preferred embodiment of the toe pan assembly 35 is connected to two actuators 30. The first actuator 30, as best seen in FIG. 3, is connected to the footrest portion 45. As with the actuators 30 previously described, there is included a jackscrew that moves a nut which itself moves a pin. As with the pedal assemblies 10 the footrest portion 45 includes a support structure 46. The support structure includes slots 70, 71, 72 and 73 which allow the footrest portion 45 to be adjusted. As with the support structure of the pedal assemblies, the support structure 46 includes first and second plates 74, 75 that are disposed parallel and spaced apart from one another. The second plate 75 defines the slots 71 and 73 which are arranged parallel to the first and second slots 70 and 72 respectively.

With reference to FIG. 1, the footrest portion 45 is connected with the toe pan portion 40 such that the units move as one piece. The toe pan portion 40, as previously mentioned is connected at one end to the footrest portion and includes at its other end a portion that is integrally connected with the support bracket 56 of the electronic throttle control pedal 13, as best shown in FIG. 1. Therefore, movement of the electronic throttle control pedal 13 thereby provides movement at one end of the toe pan portion 40 of the adjustable toe pan assembly 5.

Therefore, in use the adjustable toe pan assembly 5 is simultaneously connected with the electronic throttle control pedal 13 at one end and with the footrest portion 45 at another end. The actuator 30 associated with the electronic throttle control pedal 13 and with the footrest portion 45 are synchronized such that a constant distance is maintained between the pedals 11, 12, 13 and the toe pan portion 40. In this manner, when the pedals 11, 12, 13 are adjusted the toe pan assembly 35 is synchronized with the pedal assemblies 10 such that there is simultaneous movement of both the assemblies to maintain a specified distance.

While a preferred embodiment is disclosed, a worker in this art would understand that various modifications would come within the scope of the invention. Thus, the following claims should be studied to determine the true scope and content of this invention.

I claim:

1. An adjustable assembly comprising:
an adjustable pedal assembly including:
a support structure adapted to connect to a vehicle;
a pedal assembly including a pedal disposed adjacent the support structure and operatively coupled to the support structure;
an actuator interconnected with the pedal assembly for moving the pedal assembly to a desired position;
a toe pan assembly operatively connected to at least one actuator wherein the toe pan assembly moves in relation to the pedal assembly such that a specified distance is maintained between the pedal and the toe pan assembly.

2. The adjustable toe pan assembly of claim 1 wherein the adjustable toe pan assembly includes two adjustable pedals.

3. The adjustable toe pan assembly of claim 1 wherein the adjustable toe pan assembly includes three adjustable pedals.

4. The adjustable toe pan assembly of claim 1 wherein the toe pan assembly comprises a toe pan portion connected to a footrest portion.

5. The adjustable toe pan assembly of claim 4 wherein the toe pan portion further includes at least one recess formed therein to accommodate the pedal assembly when the pedal is depressed fully.

6. The adjustable toe pan assembly of claim 1 wherein the toe pan assembly is operatively connected to two actuators.

7. The adjustable toe pan assembly of claim 6 wherein one of the two actuators is operatively connected to the pedal assembly.

8. The adjustable toe pan assembly of claim 6 wherein the actuator interconnected with the pedal assembly operates simultaneously with the at least one actuator connected to the toe pan assembly.

9. The adjustable toe pan assembly of claim 1 wherein the toe pan assembly further includes an energy absorbing material connected therewith.

10. The adjustable toe pan assembly of claim 1 wherein the adjustable pedal assembly includes an electronic throttle control pedal.

11. The adjustable toe pan assembly of claim 10 wherein the electronic throttle control pedal includes a support structure operatively connected to the electronic throttle control pedal and affixed to the vehicle whereby the support structure does not move with respect to the vehicle when operational forces are applied to the pedal.

12. The adjustable toe pan assembly of claim 11 wherein the support structure is connected to the toe pan assembly.

13. The adjustable toe pan assembly of claim 12 wherein the electronic throttle control pedal is operatively connected to a first actuator for moving the electronic throttle control pedal and the toe pan assembly.

14. The adjustable toe pan assembly of claim 13 wherein the toe pan assembly is further connected to a second actuator.

15. An adjustable toe pan assembly comprising:
an adjustable pedal assembly including:
a support structure adapted to connect to a vehicle;
a pedal assembly including a pedal disposed adjacent the support structure and operatively coupled to the support structure;
an actuator interconnected with the pedal assembly for moving the pedal assembly to a desired position;
a toe pan assembly operatively connected to two actuators working together to provide a uniform motion and wherein the toe pan assembly moves in relation to the pedal assembly such that a specified distance is maintained between the pedal and the toe pan assembly.

16. An adjustable toe pan assembly comprising:
an adjustable pedal assembly wherein the pedal assembly includes:
a support structure adapted to connect to a vehicle;
an electronic throttle control pedal assembly including a pedal disposed adjacent the support structure and operatively coupled to the support structure;
an actuator interconnected with the electronic throttle control pedal assembly for moving the pedal assembly to a desired position;
a toe pan assembly operatively connected to a second actuator wherein the toe pan assembly moves in relation to the electronic throttle control pedal assembly such that a specified distance is maintained between the pedal and the toe pan assembly.
